(19) United States
(12) Patent Application Publication
(10) Pub. No.: US 2025/0163961 A1
(43) Pub. Date: May 22, 2025

(54) LINEAR GUIDE HAVING ANTI-CREEP RETAINER

(71) Applicant: CHIEFTEK PRECISION CO., LTD., TAINAN CITY (TW)

(72) Inventor: MING-CHE HSU, TAINAN CITY (TW)

(21) Appl. No.: 18/944,136

(22) Filed: Nov. 12, 2024

(30) Foreign Application Priority Data
Nov. 17, 2023 (TW) 112144455

(51) Int. Cl. F16C 29/04

(52) U.S. Cl. CPC F16C 29/04

(57) ABSTRACT

A linear guide includes a first rail, a second rail, and a retainer. The first rail has a first opposite side facing a second opposite side of the second rail. The first opposite side has a first raceway surface. The second opposite side has a second raceway surface. The retainer includes a plurality of rolling elements roll on the first raceway surface and the second raceway surface. A rotatable toothed wheel is pivotally connected to the retainer. A plurality of first protrusions are planted at equal intervals on the first opposite side other than the first raceway surface. A plurality of second protrusions are planted at equal intervals on the second opposite side other than the second raceway surface. The toothed wheel meshes with the first protrusions and the second protrusions to prevent the retainer from creeping on the first rail and the second rail.

### FIELD OF THE INVENTION

The present invention relates to a linear guide having an anti-creep retainer, and more particularly to a rolling element retainer of a limited-stroke linear guide. A toothed wheel meshes with a plurality of protrusions planted sequentially in the motion direction of rails to prevent the retainer from creeping on the rails. The plurality of protrusions are respectively planted on opposite sides of the two opposite rails facing each other and are not located in the raceway where the rolling elements roll, thereby improving the rigidity and load of the rails.

### BACKGROUND OF THE INVENTION

A limited-stroke linear guide includes two fixed-length rails that can move relative to each other. A slide member is provided between the two fixed-length rails for assisting in the relative movement of the two fixed-length rails. The slide member includes a retainer with a specific length and a plurality of rolling elements spaced apart by the retainer. The rolling elements roll on the raceway surfaces and bear the load. Limited-stroke linear guides are generally used in machining processes with short travel distances.

In order to prevent creep (such as offset sliding) of the retainer relative to the two fixed-length rails when the limited-stroke linear guide moves, a toothed wheel is provided on the retainer. The two fixed-length rails have toothed grooves extending in the motion direction for the toothed wheel to mesh with the toothed grooves, so that the retainer is kept in place to move.

As disclosed in Korean Patent No. KR1020210101906A, titled “CROSSED ROLLER BEARING CAPABLE OF PREVENTING RETAINER FROM CREEPING”, the toothed wheel 150 is disposed on the rolling element retainer 120. The guide rail 110 has a raceway groove for accommodating the rolling element retainer 120. The toothed groove 160 is formed on the inner surface of the raceway groove. The toothed wheel 150 meshes with the toothed groove 160.

As disclosed in Korean Patent No. KR1020210101906A, since the guide rail 110 has the raceway groove, the raceway groove is located at a thinner portion of the guide rail 110. The toothed groove 160 is formed in the raceway groove for engagement of the toothed wheel 150, which further reduces the rigidity of the guide rail 110 and reduces the load on the guide rail 110.

As disclosed in Taiwan Patent No. 200912155A, titled “LINEAR MOTION DEVICE”, the toothed wheel 261 is disposed on the roller retainer 250. The guide rail 210/220 has the groove 214/224 for accommodating the roller retainer 250. The external rack 230/240 is secured in the groove 214/224 through the rack fastener 212/222.

As disclosed in Taiwan Patent No. 200912155A, the external rack 230/240 is secured in the groove 214/224 of the guide rail 210/220, resulting in lower rigidity and loads on the guide rails 210/220. The external rack 230/240 may become loose and cause vibrations in the operation of the guide rails 210/220.

As disclosed in PCT Patent No. WO2020118770A1, titled “CROSS ROLLER GUIDE”, the first rack 21 is formed on the second guide rail 2 and the second rack 31 is formed on the retainer 3. The first gear 11 and the second gear 12 that are arranged coaxially are pivotally connected in the mounting hole 15 of the first guide rail 1 through the rotating shaft 13. In this way, the retainer can be kept in place to move.

As shown in FIG. 2 of PCT Patent No. WO2020118770A1, the coaxial first and second gears 11, 12, the rotating shaft 13 and the mounting hole 15 are all exposed on the top surface of the first guide rail 1. During the movement, the external oil and dust will easily get stuck among the first gear 11, the second gear 12 and the rotating shaft 13 or between the rotating shaft 13 and the mounting hole 15, causing the first gear 11 and the second gear 12 to rotate unsmoothly. In addition, the top surfaces of the first guide rail 1 and the second guide rail 2 are not equal in height, forming a height difference, which will affect the installation of the workpieces.

### SUMMARY OF THE INVENTION

In view of the above-mentioned shortcomings, the primary object of the present invention is to provide a linear guide, comprising a first rail, a second rail, a retainer, a plurality of first protrusions, and a plurality of second protrusions.

The first rail extends in a motion direction and has a first opposite side. The first opposite side has a first raceway surface that is recessed inwardly and extends in the motion direction. The second rail extends in the motion direction and has a second opposite side. The second opposite side has a second raceway surface that is recessed inwardly and extends in the motion direction. The first opposite side and the second opposite side face each other. The retainer extends in the motion direction and includes a plurality of rolling elements arranged in the motion direction. The rolling elements roll on the first raceway surface and the second raceway surface, enabling the retainer, the first rail and the second rail to move relative to one another in the motion direction.

A rotatable toothed wheel is pivotally connected to the retainer. The plurality of first protrusions are planted at equal intervals in the motion direction on the first opposite side other than the first raceway surface. The plurality of second protrusions are planted at equal intervals in the motion direction on the second opposite side other than the second raceway surface. The first protrusions and the second protrusions are arranged on opposite sides of a circumference of the toothed wheel. The toothed wheel meshes with the first protrusions and the second protrusions to prevent the retainer from creeping on the first rail and the second rail.

Preferably, a gap is defined between the first opposite side of the first rail and the second opposite side of the second rail. The first protrusions extend toward the second opposite side. The second protrusions extend toward the first opposite side. The first protrusions and the second protrusions each have a protruding length less than the gap.

Preferably, the first protrusions and the second protrusions are cylindrical.

Preferably, the plurality of first protrusions are respectively planted in a plurality of first circular holes of the first opposite side, and the plurality of second protrusions are respectively planted in a plurality of second circular holes of the second opposite side.

Preferably, the motion direction is straight or curved.

Preferably, the retainer has an accommodating space. An axle is provided in the accommodating space. The toothed wheel is pivotally connected to the axle in the accommodating space. The toothed wheel partially extends out of the retainer.

According to the above technical features, the present invention can achieve the following effects:
1. In the prior art, the rack used for meshing the toothed wheel of the retainer is disposed in the raceway groove of the guide rail and the rack is directly formed in the raceway groove, which reduces the rigidity of the guide rail and also reduces the load capacity of the guide rail. In the present invention, the first protrusions of the first rail, used for meshing the toothed wheel of the retainer, are disposed on the first opposite side and are not located on the first raceway surface, the second protrusions of the second rail, used for meshing the toothed wheel of the retainer, are disposed on the second opposite side and are not located on the second raceway surface. Neither the first raceway surface nor the second raceway surface is further machined to form a rack, such that the integrity of the first raceway surface and the second raceway surface is completely kept. This enables the first rail and the second rail to have better rigidity and withstand higher loads.
2. In the present invention, the first protrusions of the first rail are planted in the first circular holes of the first opposite side other than the first raceway surface, and the second protrusions of the second rail are planted in the second circular holes of the second opposite side other than the second raceway surface. In the present invention, the first and second protrusions are planted in the first and second opposite sides other than the first and second raceway surfaces. The operating space for planting the protrusions is not restricted, so the protrusions can be planted easily. In the prior art, the raceway surface is machined to form the rack. The space for machining the rack is restricted. It is not easy to machine the raceway surface to form the rack.
3. In the present invention, the first circular holes and the second circular holes are located away from the first raceway surface and the second raceway surface. The first circular holes and the second circular holes will not affect the rigidity of the first raceway surface and the second raceway surface at all. Besides, the first circular holes and the second circular holes are located outside the first raceway surface and the second raceway surface. Therefore, the first circular holes and the second circular holes are deep enough to secure the first protrusions and the second protrusions in place without loosening.
4. In the present invention, the retainer has the accommodating space. The toothed wheel is pivotally connected to the axle in the accommodating space. The toothed wheel partially extends out of the retainer, so as to minimize oil and dust from affecting the rotation of the toothed wheel.

### BRIEF DESCRIPTION OF THE DRAWINGS

FIG. 1 is an exploded view of the linear guide of the present invention;

FIG. 2 is a schematic view of the linear guide of the present invention, illustrating that the first opposite side of the first rail faces the second opposite side of the second rail;

FIG. 3 is a partial perspective view of the linear guide of the present invention;

FIG. 4 is a schematic view of the present invention, illustrating that the toothed wheel of the retainer meshes with the first protrusions and the second protrusions;

FIG. 5 is a cross-sectional view of FIG. 3; and

FIG. 6 is a schematic view of the present invention, illustrating that the first protrusions of the first rail are planted in the first circular holes and the second protrusions of the second rail are planted in the second circular holes.

### DESCRIPTION OF THE PREFERRED EMBODIMENTS

Embodiments of the present invention will now be described, by way of example only, with reference to the accompanying drawings.

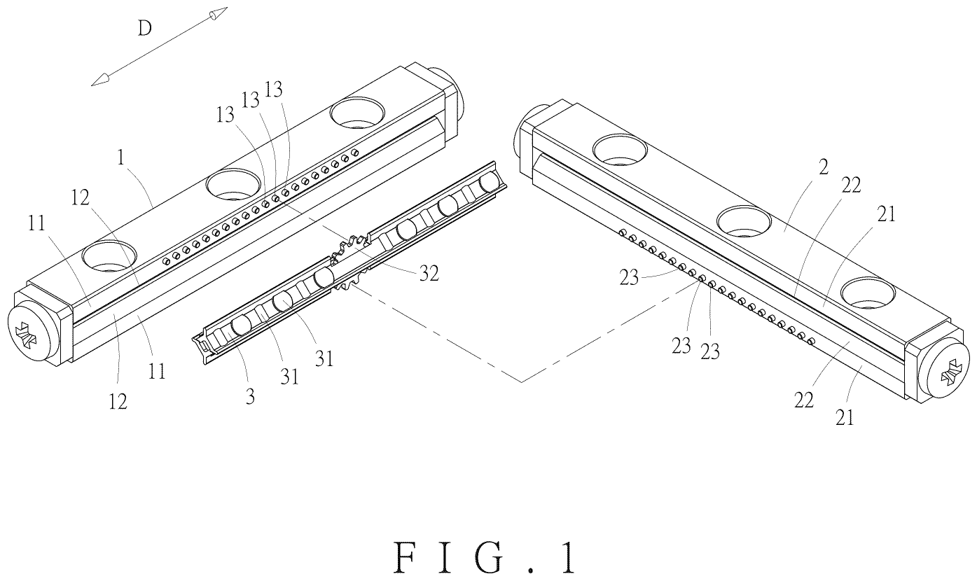

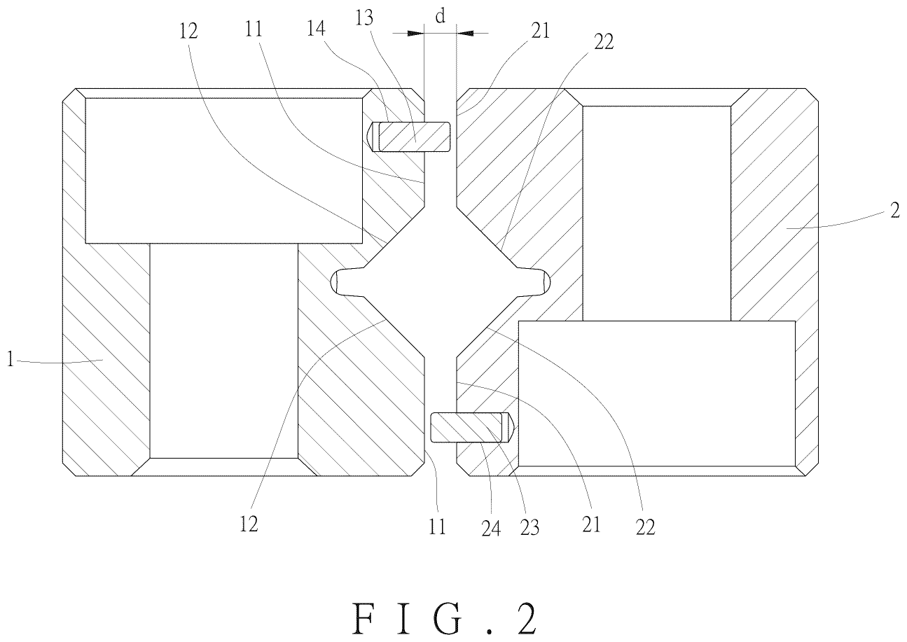

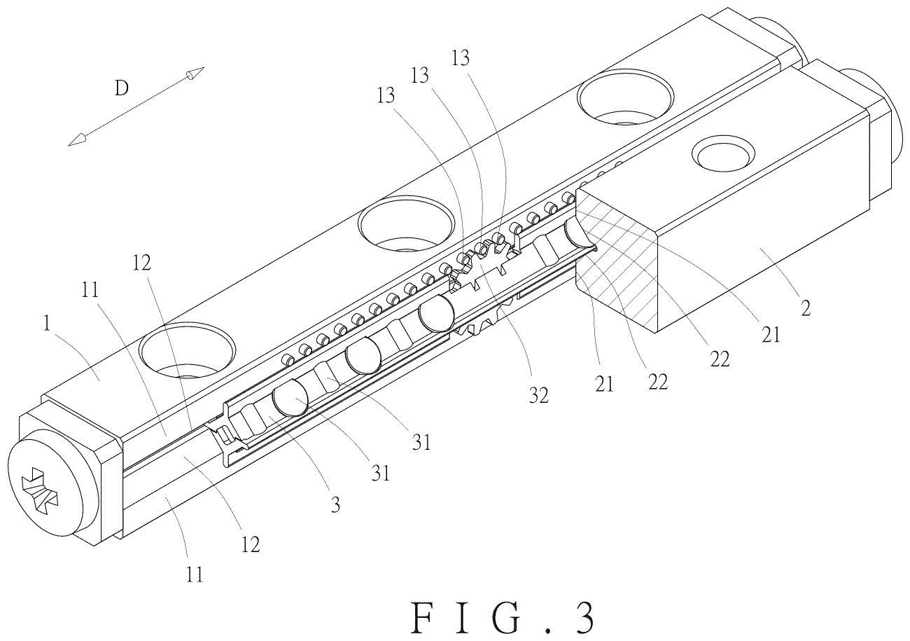

As shown in FIG. 1, FIG. 2 and FIG. 3, the present invention discloses a linear guide having an anti-creep retainer. The linear guide comprises a first rail 1, a second rail 2, and a retainer 3.

The first rail 1 extends in a motion direction D. The first rail 1 has a first opposite side 11. The first opposite side 11 has a first raceway surface 12 that is recessed inwardly and extends in the motion direction D. The second rail 2 extends in the motion direction D. The second rail 2 has a second opposite side 21. The second opposite side 21 has a second raceway surface 22 that is recessed inwardly and extends in the motion direction D. The first opposite side 11 and the second opposite side 21 face each other, that is, the first opposite side 11 faces the second rail 2 and the second opposite side 21 faces the first rail 1. The first raceway surface 12 of the first opposite side 11 and the second raceway surface 22 of the second opposite side 21 are configured for rolling elements 31 to roll thereon. The retainer 3 extends in the motion direction D and includes a plurality of rolling elements 31 arranged in the motion direction D. In this embodiment, the rolling elements 31 are rollers that are staggered with respect to each other by 90 degrees and roll on the first raceway surface 12 and the second raceway surface 22, enabling the retainer 3, the first rail 1 and the second rail 2 to move relative to one another in the motion direction D. The motion direction D may be straight or curved, etc., depending on the needs of the process.

Referring to FIG. 1 through FIG. 4, a rotatable toothed wheel 32 is pivotally connected to the retainer 3. A plurality of first protrusions 13 are planted at equal intervals in the motion direction D on the first opposite side 11 other than the first raceway surface 12. A plurality of second protrusions 23 are planted at equal intervals in the motion direction D on the second opposite side 21 other than the second raceway surface 22. The toothed wheel 32 meshes with the first protrusions 13 and the second protrusions 23 to prevent the retainer 3 from creeping on the first rail 1 and the second rail 2 and to make both the first rail 1 and the second rail 2 more rigid and able to withstand higher loads. In this embodiment, the first protrusions 13 and the second protrusions 23 are cylindrical, which facilitates smooth guidance of the toothed wheel 32.

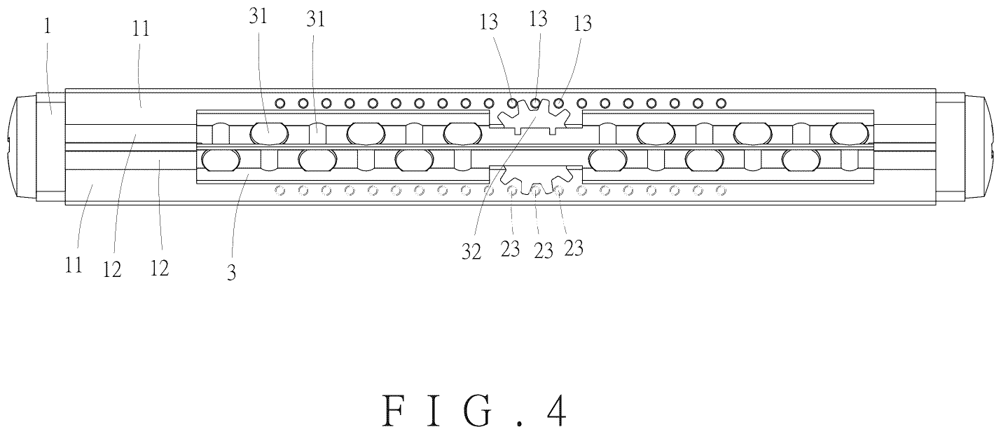

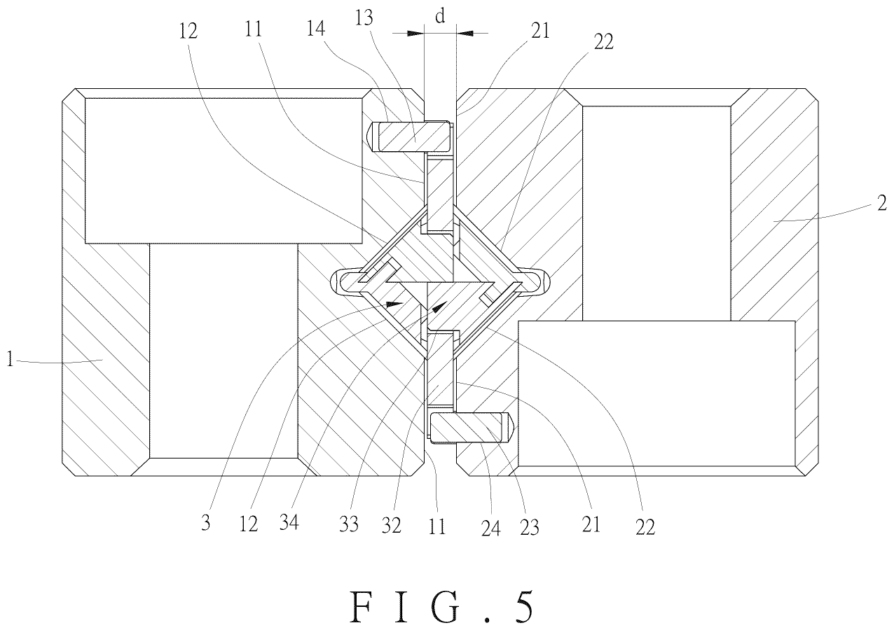

Referring to FIG. 4 and FIG. 5, in the embodiment, the first protrusions 13 are located on the upper edge of the first opposite side 11 of the first rail 1, and the second protrusions 23 are located on the lower edge of the second opposite side 21 of the second rail 2, such that the first protrusions 13 and the second protrusions 23 are arranged on opposite sides of the circumference of the toothed wheel 32 for the toothed wheel to mesh with first protrusions 13 and the second protrusions 23. Specifically, in this embodiment, a gap d is defined between the first opposite side 11 of the first rail 1 and the second opposite side 21 of the second rail 2. The first protrusions 13 extend toward the second opposite side 21 and each have a protruding length less than the gap d. The second protrusions 23 extend toward the first opposite side 11 and each have a protruding length less than the gap d. This can prevent the first rail 1 and the second rail 2 from colliding with the first protrusions 13 and the second protrusions 23 when they move relative to each other. In this embodiment, the retainer 3 consists of two half retainers coupled to each other, as shown in FIG. 5, but not limited thereto. It may be integrally formed according to the mold design. The retainer 3 has an accommodating space 33. An axle 34 is provided in the accommodating space 33. The toothed wheel 32 is pivotally connected to the axle 34 in the accommodating space 33. The toothed wheel 32 partially extends out of the retainer 3, so as to minimize oil and dust from affecting the rotation of the toothed wheel 32.

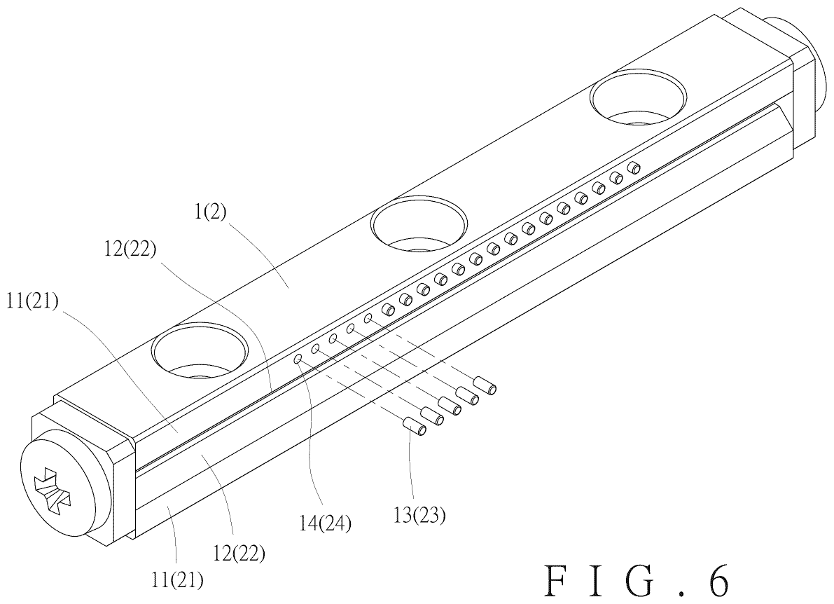

Referring to FIG. 5 and FIG. 6, in the embodiment, the plurality of first protrusions 13 are planted in a plurality of first circular holes 14 of the first opposite side 11 of the first rail 1, respectively. Similarly, the plurality of second protrusions 23 are planted in a plurality of second circular holes 24 of the second opposite side 21 of the second rail 2, respectively. (Since the second rail 2 and the first rail 1 are symmetrical, the first rail 1 can be used as the second rail 2 by turning the first rail 1 by 180 degrees during production, both the first rail 1 and the second rail 2 are labeled in FIG. 5.) Further, after applying adhesive to the first protrusions 13 and the second protrusions 23, they are inserted into the first circular holes 14 and the second circular holes 24, respectively. Thereby, the first protrusions 13 can be more securely disposed on the first rail 1 and less prone to loosening, and the second protrusions 23 can be more securely disposed on the second rail 2 and less prone to loosening.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A linear guide, comprising:
a first rail, extending in a motion direction and having a first opposite side, the first opposite side having a first raceway surface that is recessed inwardly and extends in the motion direction;
a second rail, extending in the motion direction and having a second opposite side, the second opposite side having a second raceway surface that is recessed inwardly and extends in the motion direction, the first opposite side and the second opposite side facing each other;
a retainer, extending in the motion direction and including a plurality of rolling elements arranged in the motion direction, the rolling elements rolling on the first raceway surface and the second raceway surface, enabling the retainer, the first rail and the second rail to move relative to one another in the motion direction, a rotatable toothed wheel being pivotally connected to the retainer;
a plurality of first protrusions, planted at equal intervals in the motion direction on the first opposite side other than the first raceway surface;
a plurality of second protrusions, planted at equal intervals in the motion direction on the second opposite side other than the second raceway surface;
wherein the first protrusions and the second protrusions are arranged on opposite sides of a circumference of the toothed wheel, and the toothed wheel meshes with the first protrusions and the second protrusions to prevent the retainer from creeping on the first rail and the second rail.

2. The linear guide as claimed in claim 1, wherein a gap is defined between the first opposite side of the first rail and the second opposite side of the second rail, the first protrusions extend toward the second opposite side, the second protrusions extend toward the first opposite side, and the first protrusions and the second protrusions each have a protruding length less than the gap.

3. The linear guide as claimed in claim 1, wherein the first protrusions and the second protrusions are cylindrical.

4. The linear guide as claimed in claim 1, wherein the plurality of first protrusions are respectively planted in a plurality of first circular holes of the first opposite side, and the plurality of second protrusions are respectively planted in a plurality of second circular holes of the second opposite side.

5. The linear guide as claimed in claim 1, wherein the motion direction is straight or curved.

6. The linear guide as claimed in claim 1, wherein the retainer has an accommodating space, an axle is provided in the accommodating space, the toothed wheel is pivotally connected to the axle in the accommodating space, and the toothed wheel partially extends out of the retainer.
